(19) United States
(12) Patent Application Publication
(10) Pub. No.: US 2025/0331442 A1
(43) Pub. Date: Oct. 30, 2025

(54) SYSTEM AND METHOD FOR CONTROLLING HYDRAULIC PUMP OPERATION WITHIN A WORK VEHICLE WHEN SUPPLYING FLUID POWER TO EXTERNAL IMPLEMENTS

(71) Applicant: CNH Industrial America LLC, New Holland, PA (US)

(72) Inventors: Patrick Michael Joseph Stump, Ashland, KY (US); Ryan P. Jenkins, Oak Brook, IL (US); Xiaofan Guo, Simpsonville, SC (US); Jacob Lengacher, Lafayette, IN (US); Andrea Vacca, West Lafayette, IN (US)

(21) Appl. No.: 18/647,586

(22) Filed: Apr. 26, 2024

(51) Int. Cl. A01B 71/02; F15B 19/00

(52) U.S. Cl. CPC A01B 71/02; F15B 19/005

(57) ABSTRACT

A method for controlling an operation of a pump of a work vehicle when supplying pressurized fluid to an implement coupled to the work vehicle includes receiving data indicative of an actual output pressure for the pump and an input pump parameter associated with the pump, and determining a predicted output pressure for the pump based at least in part on the input pump parameter. The method also includes determining a prediction error based at least in part on the actual and predicted output pressures for the pump, and determining a correlation between the prediction error and the input pump parameter. Additionally, the method includes controlling the operation of the pump to adjust the actual output pressure for the pump towards a target output pressure based at least in part on the correlation between the prediction error and the input pump parameter.

### FIELD OF THE INVENTION

The present disclosure generally relates to hydraulic systems for work vehicles, such as agricultural tractors or other agricultural vehicles, that are used to supply fluid power to external implements, such as planters, seeders, and/or tillage implements being toward by the respective vehicles. More specifically, the present disclosure is directed to systems and methods for controlling the operation of a pump of a work vehicle's hydraulic system in a manner that minimizes the required pump output pressure when supplying hydraulic fluid to satisfy the fluid power requirements of an external implement.

### BACKGROUND OF THE INVENTION

A work vehicle, such as an agricultural tractor, typically includes a hydraulic system to actuate various components of the vehicle or an associated implement. For example, the hydraulic system may drive one or more hydraulic functions, such as one or more loads (e.g., a bulk fill fan, a fertilizer fan, a vacuum fan, etc.), an alternator/generator, and/or other devices mounted on the implement. As such, the hydraulic system generally includes one or more hydraulic components (e.g., hydraulic actuators, motors, and/or the like) for driving the functions and a pump configured to supply hydraulic fluid to the hydraulic component(s).

State-of the-art work vehicles typically use a load-sensing (LS) hydraulic system to provide fluid power to an external implement. With these systems, flow control is often achieved using a remote valve, whereby the valve opening corresponds to a commanded flow rate. The LS pump senses the remote load pressure of the implement (e.g., via an associated LS circuit) and attempts to maintain the pump output pressure equal to the remote load pressure plus a given margin. Unfortunately, modern implements typically include multiple hydraulic functions that connect to a single remote valve. Since these functions use their own implement-based control valves, a conflict is created with the remote valve, which causes the pump to raise its pressure to the maximum allowable pressure. This, in turn, results in very poor hydraulic efficiency, increased fuel consumption, increased heat generation, and decreased power available for other vehicle functions.

Recent advancements have attempted to address the issues associated with conventional LS hydraulic systems by adding pressure sensors on the implement to monitor the pressure of the implement's hydraulic functions. The sensed, implement-side pressure data is then used to control the pump output pressure to either a fixed or optimized pressure margin. However, these solutions require that the implement either be retrofitted with pressure sensors (along with the associated data acquisition systems) or newly designed with pressure sensors and the related data acquisition systems. In addition, these solutions require constant communication with the implement.

Accordingly, an improved system and method for controlling pump operation within a work vehicle when supplying hydraulic fluid to an external implement that does not rely on load-sensing systems and/or implement-based pressure sensors would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a method for controlling an operation of a pump of a work vehicle when supplying pressurized fluid to an implement coupled to the work vehicle. The method includes receiving, with a computing system, data indicative of an actual output pressure for the pump and an input pump parameter associated with the pump, and determining, with the computing system, a predicted output pressure for the pump based at least in part on the input pump parameter. The method also includes determining, with the computing system, a prediction error based at least in part on the actual and predicted output pressures for the pump, and determining, with the computing system, a correlation between the prediction error and the input pump parameter. Additionally, the method includes controlling, with the computing system, the operation of the pump to adjust the actual output pressure for the pump towards a target output pressure based at least in part on the correlation between the prediction error and the input pump parameter.

In another aspect, the present subject matter is directed to a system for supplying pressurized fluid from work vehicles to external implements. The system includes a work vehicle coupled to an implement. The work vehicle includes a pump configured to supply pressurized hydraulic fluid to a hydraulic component of the implement. Additionally, the system includes a computing system communicatively coupled to the pump. The computing system is configured to receive data indicative of an actual output pressure for the pump and an input pump parameter associated with the pump, determine a predicted output pressure for the pump based at least in part on the input pump parameter, and determine a prediction error based at least in part on the actual and predicted output pressures for the pump. Additionally, the computing system is configured to determine a correlation between the prediction error and the input pump parameter, and control the operation of the pump to adjust the actual output pressure for the pump towards a target output pressure based at least in part on the correlation between the prediction error and the input pump parameter.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle and an associated implement in accordance with aspects of the present subject matter;

FIG. 2 illustrates a side view of the work vehicle shown in FIG. 1 and an alternative embodiment of the associated implement in accordance with aspects of the present subject matter;

FIG. 3 illustrates a simplified, schematic view of one embodiment of a system configured for use with a work vehicle and associated implement for supplying pressurized hydraulic fluid from the vehicle to satisfy the various hydraulic requirements or loads of the implement in accordance with aspects of the present subject matter;

FIG. 4 illustrates a schematic view of a flow diagram providing one embodiment of pressure control logic that can be executed in accordance with aspects of the present subject matter when controlling the operation of a pump;

FIG. 5 illustrates a schematic view of an example operation of the short-moving average (SMA) block shown in FIG. 4 in accordance with aspects of the present subject matter;

FIG. 6 illustrates a schematic view of an example operation of the log-moving average (LMA) block shown in FIG. 4 in accordance with aspects of the present subject matter;

FIGS. 7A-C illustrate an example flow diagram representing one embodiment of control logic associated with the operation of the DSM block shown in FIG. 4 in accordance with aspects of the present subject matter;

FIG. 8 illustrates a schematic view of example control logic 360 suitable for use with the long-moving average (LMA) block shown in FIG. 4 when executing the DSM logic of FIGS. 7A-C in accordance with aspects of the present subject matter;

FIG. 9 illustrates an example data series that charts system pressures (e.g., pump output pressure and input pressure) as well as the input flow rate to an implement over time during execution of the control logic disclosed herein in accordance with aspects of the present subject matter;

FIG. 10 illustrates a schematic view of one embodiment of a computing system in accordance with aspects of the present subject matter; and

FIG. 11 illustrates a flow diagram of one embodiment of a method for controlling an operation of a pump of a work vehicle when supplying pressurized fluid to an implement coupled to the work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling pump operation within a work vehicle when supplying hydraulic fluid to an external implement. As opposed to relying on a load-sensing circuit or implement-based pressure sensors to monitor the hydraulic demands of the implement, the disclosed system utilizes a model-based approach to infer when the output pressure of the pump is insufficient to satisfy the implement's hydraulic demands. Specifically, as will be described below, the system model makes certain assumptions about the input flow rate to the implement that intentionally introduces a prediction error in the modelled output that exhibits a higher correlation to an input parameter of the pump when the output pressure is too low. Thus, by analyzing the correlation between the system error and the pump input parameter, the system can determine or infer the sufficiency of the pump output pressure without requiring a load-sensing circuit or implement-based pressure sensors.

It should be appreciated that, in several embodiments, the correlation being analyzed between the system error and the pump input parameter corresponds to a cross-correlation between the error/input. However, in other embodiments, any other suitable function or method may be used to establish a correlation or relationship between the system error and the pump input parameter. For instance, the correlation between the system error and the pump input parameter may be established using neural networks, fuzzy logic, and/or any other suitable mathematical correlation functions.

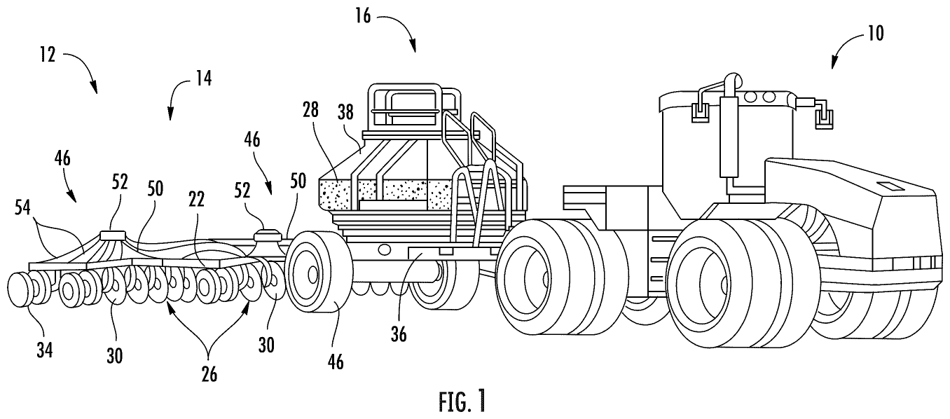

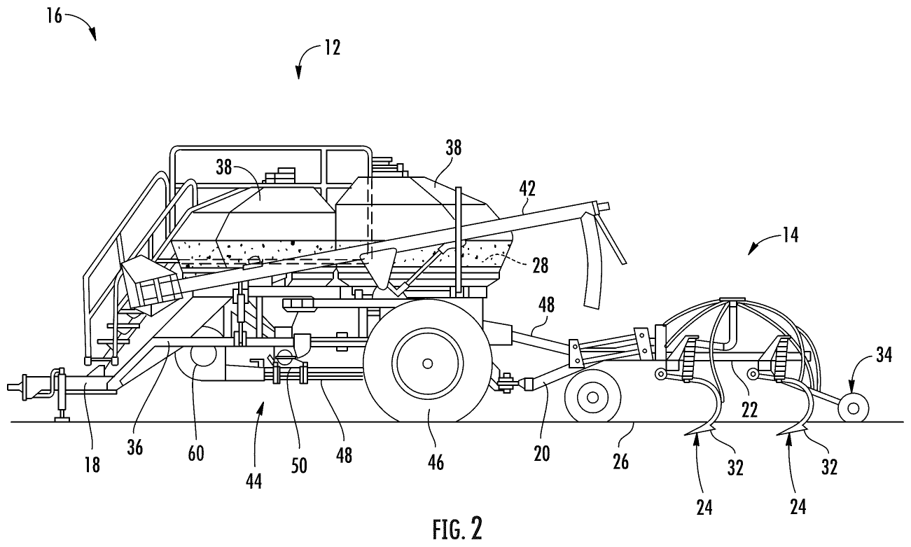

Referring now to the drawings, FIGS. 1 and 2 illustrate differing side views of one embodiment of a work vehicle 10 and an associated implement 12. Specifically, FIG. 1 illustrates a side view of the work vehicle 10 and one embodiment of the associated implement 12. Additionally, FIG. 2 illustrates a side view of the work vehicle 10 and another embodiment of the associated implement 12. As shown, the implement 12 may be configured as a seed planting device 14 and an associated air cart 16 and the work vehicle 10 may be configured as an agricultural tractor. However, in other embodiments, the implement 12 may be configured as any other suitable type of implement, such as another seed dispensing implement, a tillage implement, and/or the like. Similarly, in alternative embodiments, the work vehicle 10 may be configured as any other suitable type of vehicle, such as another agricultural vehicle (e.g., an agricultural harvester, a self-propelled sprayer, etc.), a construction vehicle, and/or the like.

As shown, the air cart 16 may be configured to be towed directly behind the work vehicle 10, with the seed planting device 14 being towed behind the air cart 16. In this regard, a hitch assembly 18 (FIG. 2) may be configured to couple the air cart 16 to the work vehicle 10. Although the hitch assembly 18 is illustrated in FIG. 2 as corresponding to a hitch of the air cart 16, the hitch assembly 18 may also correspond to a hitch of the work vehicle 10. Furthermore, a hitch assembly 20 may be configured to couple the seed planting device 14 to the air cart 16. Although the hitch assembly 20 (FIG. 2) is illustrated as corresponding to a hitch of the seed planting device 14, the hitch assembly 20 may also correspond to a hitch of the air cart 16. Additionally, in alternative embodiments, the seed planting device 14 may be towed directly behind the work vehicle 10, with the air cart 16 being towed behind the seed planting device 14. For example, in such embodiments, the seed planting device 14 may be coupled to the work vehicle 10 via the hitch assembly 20 and the air cart 16 may be coupled to the seed planting device 14 via the hitch assembly 18.

In several embodiments, the seed planting device 14 may include a frame 22 configured to support or couple to various components of the seed planting device 14, such as one or more ground-engaging tools 24. In general, the ground-engaging tool(s) 24 may be configured to excavate a furrow or trench in soil 26 to facilitate deposition of a flowable granular or particulate-type agricultural product 28, such as seeds, fertilizer, and/or the like. For example, in the embodiment illustrated in FIG. 1, each ground-engaging tool 24 may be configured as an opener disc 30. Alternatively, in the embodiment shown in FIG. 2, each ground-engaging tool 24 may be configured as a hoe or shank 32. Furthermore, the seed planting device 14 may generally include any number of ground-engaging tools 24 to facilitate delivery of the agricultural product 28 across a given swath of the soil 26. Additionally, the seed planting device 14 may also include one or more closing wheels or discs 34 configured to close the furrow after the agricultural product 28 has been deposited into the furrow.

Moreover, the air cart 16 may be configured to store the agricultural product 28 to be deposited within the soil 26. Specifically, in several embodiments, the air cart 16 may include a frame 36 configured to support or couple to various components of the air cart 16. For example, as shown, the frame 36 may be configured to support a hopper or storage tank 38 configured for storing the agricultural product 28 to be deposited within the furrow. The frame 36 may also be configured to support a vacuum fan or pressurized air source 60 (FIG. 2) and a tank filling mechanism 42 (FIG. 2), such as an auger, conveyor, and/or the like. Moreover, a metering system 44 (FIG. 2) may be supported on the frame 36. Additionally, in one embodiment, a plurality of wheels 46 may be coupled to the frame 36 to permit the air cart 16 to be towed across a field by the work vehicle 10.

Furthermore, a plurality of delivery conduits 48 of the implement 12 may be configured to convey the agricultural product 28 from the air cart 16 to the seed planting device 14 for deposition into the furrow. Specifically, in several embodiments, the agricultural product 28 contained within the hopper 38 may be gravity fed into the metering system 44. As such, the metering system 44 may be configured to distribute a desired quantity of the agricultural product 28 to the delivery conduits 48. For example, in one embodiment, a primary header 50 (FIG. 2) coupled between the metering system 44 and the delivery conduits 48 may direct the agricultural product 28 into each of the delivery conduits 48. Pressurized air provided by the fan 60 to the delivery conduits 48 may then carry the agricultural product 28 through the delivery conduits 48 to the seed planting device 14.

It should be appreciated that the configuration of the work vehicle 10 and the implement 12 described above and shown in FIGS. 1 and 2 is provided only to place the present subject matter in an exemplary field of use. Thus, it should be appreciated that the present subject matter may be readily adaptable to any manner of work vehicle and/or implement configuration.

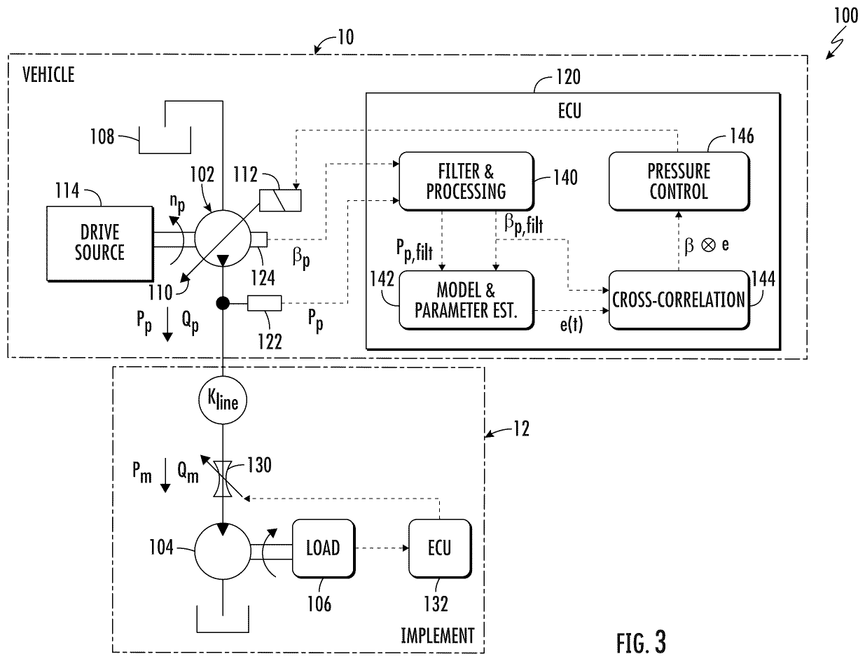

Referring now to FIG. 3, a simplified, schematic view of one embodiment of a system 100 configured for use with a work vehicle and associated implement for supplying pressurized hydraulic fluid from the vehicle to satisfy the various hydraulic requirements or loads of the implement is illustrated in accordance with aspects of the present subject matter. For purposes of discussion, the system 100 will generally be described below in view of the work vehicle 10 and implement 12 shown and described above with reference to FIGS. 1 and 2. However, it should be appreciated that the system 100 may generally be utilized within any suitable work vehicle have any suitable vehicle configuration and/or with any suitable implement have any suitable implement configuration. For purposes of illustration, hydraulic connections between components of the system 100 are shown in solid lines, while electrical connections between components of the system 100 (as well as controller-related flows) are shown in dashed lines. Additionally, the work vehicle 10 and implement 12 are schematically illustrated in FIG. 3 using dash-dot lines.

In several embodiments, the system 100 may include both a work vehicle 10 and an implement 12, as well as various vehicle-side components and implement-side components. For instance, as shown in FIG. 3, the system 100 may include a pump 102 positioned on or within the work vehicle 10 for supplying pressurized hydraulic fluid to one or more hydraulic components of the work vehicle 10 and/or implement 12. In the illustrated embodiment, the pump 102 is configured to supply hydraulic fluid through one or more fluid lines or conduits to a hydraulic motor 104 of the implement 12, which, in turn, is configured to rotationally drive a given hydraulic load 106 of the implement 12 (e.g., a fan, alternator, or any other hydraulically-driven load of the implement 12). Other hydraulic components of the implement 12 may include, for example, hydraulic cylinders and/or any other suitable fluid-driven components. It should be appreciated that, although a single hydraulic component and associated load are shown in FIG. 3 (e.g., the motor/load 104, 106), the pump 102 may be configured to supply pressurized fluid to any suitable number of hydraulic components of the implement 12 for driving a corresponding number of implement-based hydraulic loads.

As shown, the pump 102 may be in fluid communication with a fluid tank or reservoir 108 to allow hydraulic fluid stored within the reservoir 108 to be pressurized and supplied to the hydraulic component(s) of the implement 12. In several embodiments, the pump 102 may correspond to an electronically controlled, variable displacement pump configured to discharge hydraulic fluid across a given pressure range. Specifically, the pump 102 may supply pressurized hydraulic fluid within a range bounded by a minimum/maximum pressure capability of the variable displacement pump. In this respect, the pump 106 may include a swash plate 110 that is controlled electronically via a swashplate actuator 112 (e.g., a solenoid-driven actuator) to adjust the position of the swash plate 110, as necessary, to vary the output pressure of the pump 102. In several embodiments, the pump 102 may be rotationally driven by a given drive source 114 of the work vehicle 10. For instance, in one embodiment, the drive source 114 may correspond to an engine of the work vehicle 10. In such an embodiment, the input speed of the pump 102 may generally be determined as a function of the speed of the vehicle's engine.

To control the operation of the pump 102, the system 100 may include a vehicle-side electronic control unit (ECU) or controller 120 communicatively coupled to the pump 102. Specifically, in several embodiments, the vehicle-side controller 120 (or simply “controller 120”) may be configured to control the operation of the pump 102 to adjust the pump output pressure to a minimum target output pressure that is sufficient to satisfy the hydraulic loads of the implement 12. As will be described in greater detail below, such pump control can be achieved without requiring any communication with the implement 12, such as load sensing circuits or data transmission from implement-side sensors.

In several embodiments, the controller 120 may be configured to receive various input signals and/or may have certain data stored within its memory to allow for the execution of the pump control described herein. For instance, as shown in FIG. 3, the controller 120 may be communicatively coupled to a pressure sensor 122 for receiving data indicative of the output pressure, Pₚ, of the pump 102, and a displacement sensor 124 for receiving data indicative of a fractional displacement, βₚ, of the pump 102. Additionally, although not shown, the controller 120 may also be communicatively coupled to a speed sensor for receiving data indicative of the input speed, nₚ, of the pump 102. For instance, when the drive source 114 corresponds to the vehicle's engine, sensor data associated with the engine speed may be used to derive or determine the input speed to the pump 102. The controller 120 may also receive input signals related to any suitable commands sent to any on-tractor hydraulic functions (not shown), such as remote valves, the hitch, and/or the like. Moreover, the data stored within the controller 120 may include pump-related data, such as volumetric efficiency maps and/or other operating maps/data associated with the pump 102.

On the implement-side, the system 100 may include a flow control valve 130 configured to regulate the flow rate Qₘ, of the pressurized fluid supplied to the implement-side hydraulic components, such as the input flow rate to the hydraulic motor 104. In one embodiment, the flow control valve 130 may correspond to an electronically controlled valve. In such an embodiment, an implement-based electronic control unit (ECU) or controller 132 may be provided to electronically control the operation of the flow control valve 130. For instance, the implement-based controller 132 may be configured to control the valve operation to regulate the input flow rate to the hydraulic motor 104 based on a commanded flow rate, Q_{cmd}, needed to satisfy the requirements of the associated hydraulic load(s)/function(s) of the implement 12.

In several embodiments, the vehicle-based controller 120 may include or be configured to execute one or more modules for processing data, calculating various parameters, controlling pump operation, and/or the like. For instance, in the illustrated embodiment, the controller 120 includes or is configured to execute a filter/preprocessing module 140, a model and parameter estimation module 142, a cross-correlation module 144, and a pressure control module 146. The filter/preprocessing module 142 may be configured to receive raw or partially filtered/processed input data (e.g., sensor data from the pressure sensor 122 indicative of the output pressure, Pₚ, for the pump 102 and sensor data from the displacement sensor 124 indicative of the fractional displacement, βₚ, for the pump 102) and generate filtered/processed output data used for subsequent processing by the controller 120 (e.g., a filtered/processed output pressure, P_{p,filt}, for the pump 102 and a filtered/processed fractional pump displacement, β_{p,filt}, for the pump 102). As indicated above, the controller 120 may also be configured to receive other input signals and/or may have certain data stored within its memory, such as input data associated with the input speed of the pump 102 (e.g., engine speed data) and commands sent to on-tractor hydraulic function, as well as pre-stored pump data (e.g., volumetric efficiency maps for the pump 102).

In several embodiments, the model and parameter estimation module 142 may be configured to utilize the pump fractional displacement, along with the engine speed and stored volumetric efficiency maps, to estimate an output flow rate, Qₚ, for the pump 102. Such data is then used by the model and parameter estimation module 142 as input signals into a model of the hydraulic system that is configured to estimate a pump output pressure, Pₚ, as a function of the estimated output flow rate for the pump 102. The model and parameter estimation module 142 may also be configured to use parameter estimation to adapt the system model in a manner that ensures that the model reflects the line capacitance, Kₗᵢₙₑ, of the attached implement 12. For instance, as will be described below, the module 142 may use an ARIX (Auto Regressive Integrator with exogenous input) model structure to reflect the line capacitance. Ultimately, the rate of change of the predicted pump output pressure provided by the model is compared with the actual pump output pressure rate (e.g., as measured using the pressure sensor 122) to determine a model prediction error, while a small oscillating perturbation of the pump displacement faction is imposed to maintain persistent excitation conditions.

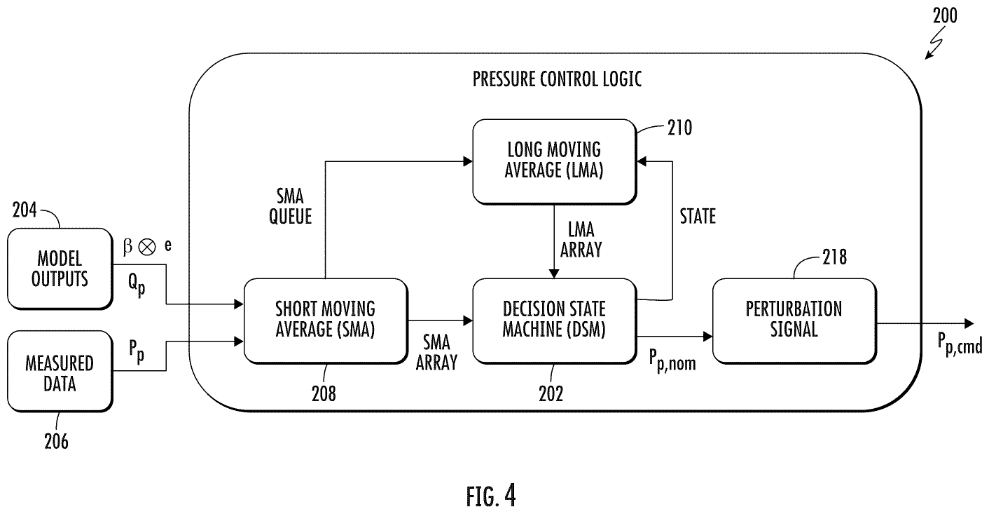

This model prediction error is then stored in a memory buffer and used by the cross-correlation module 144 to determine a cross-correlation between the prediction error and a given pump input parameter, such as by determining the cross-correlation, β⊗e, between the prediction error and the pump fractional displacement. This cross-correlation, along with the pump output pressure and estimated pump output flow rate, are then used as inputs by the pressure control module 146 to control the operation of the pump 102. For instance, as will be described below with reference to FIG. 4, the cross-correlation between the prediction error and the pump fractional displacement can be used by the controller 120 as an indicator of whether the pump output pressure is sufficiently high to satisfy the flow requirements of the implement-based hydraulic loads. Specifically, assuming constant (or near-constant) flow requirements, the model prediction error generally manifests as small-amplitude white noise with no or minimal correlation to the pump fractional displacement. However, if the pump output pressure is insufficient to satisfy the flow requirements of the implement-based hydraulic loads, a discrepancy will exist between the measured and predicted pump output pressure rates, which will result in an elevated cross-correlation between the model prediction error and the pump fractional displacement. In this regard, the pressure control module 146 may generally be configured to maintain or log the data history of the various cross-correlation events and use this information to adjust the output pressure setpoint for the pump 102 towards a minimum target pressure setpoint that satisfies all of the flow requirements of the implement-based hydraulic loads (e.g., a minimum pressure setpoint having a given margin above the required hydraulic load pressures). It should be appreciated that, in other embodiments, any other suitable methodology and/or function may be used to establish a correlation between the prediction error and the pump input parameter, such as by using neural networks, fuzzy logic and/or any other suitable mathematical correlation functions or methods.

To allow the pump output pressure to be estimated as a function of the estimated output flow rate for the pump 102, the system model generally utilizes the following governing equation (Equation 1):

$${\dot{p}}_{p} = {K}_{line} ( {Q}_{p} - {Q}_{m} ) \qquad ( 1 )$$

wherein, \dot{p}ₚ corresponds to the rate of change in the output pressure, Pₚ, for the pump 102, Kₗᵢₙₑ corresponds to the line capacitance associated with the attached implement 12, Qₚ corresponds to output flow rate for the pump 12, and Qₘ corresponds to the input flow rate into the implement 12.

Within the governing equation, the output flow rate, Qₚ, for the pump 102 can calculated based on known or measured inputs, namely the volumetric efficiency maps (e.g., as stored in the controller's memory), the input speed to the pump 102 (e.g., as determined based on the engine speed of the vehicle), the maximum pump displacement (e.g., a known value stored in the controller's memory), and the fractional displacement of the pump (e.g., as determined based on the data from the displacement sensor 124).

The input flow rate, Qₘ, to the implement 12 is generally a function of the input pressure, Pₘ, to the implement 12, the pump output pressure, Pₚ, (e.g., as determined based on data from the pressure sensor 122) and the commanded flow rate, Q_{cmd}, to the flow control valve 13—(e.g., as commanded by the implement-based controller 132). However, since the input pressure, Pₘ, to the implement 12 is not measured or known to the controller 120, the system model is implemented by assuming that the input flow rate, Qₘ, is constant. Specifically, the input flow rate, Qₘ, is assumed to be equal to the commanded flow rate, Q_{cmd}, which is generally accurate when the pump output pressure is sufficient to satisfy the flow requirements of the implement-based hydraulic loads. However, when the pump output pressure is insufficient to satisfy the flow requirements of the implement-based hydraulic loads, the assumption of a constant input flow rate, Qₘ, breaks down, thereby introducing a system error into the model. As will be described later, this intentionally introduced error can be advantageously utilized to determine when the pump output pressure is too low (e.g., based on the cross-correlation between the prediction error and a pump input parameter, such as the pump fractional displacement). It should be appreciated that the commanded flow rate, Q_{cmd}, is not known to the controller 120. Thus, in view of the system assumption, the input flow rate, Qₘ, is estimated using a parameter estimation methodology, as will be described below.

A general summary of the system assumption made for the input flow rate, Qₘ, is provided below (Equation 2):

$${Q}_{m} = \{ \begin{matrix}{Q}_{cmd} , & if {p}_{p} \geq {p}_{p}^{*} \\ {Q}_{cmd} - {Q}_{e} , & if {p}_{p} < {p}_{p}^{*}\end{matrix} \qquad ( 2 )$$

wherein, Qₘ corresponds to the input flow rate into the implement 12, Q_{cmd} corresponds to the commanded flow rate transmitted to the flow control valve 130, pₚ corresponds to the pump output pressure (e.g., as determined based on data from the pressure sensor 122), pₚ* corresponds to the minimum target pump output pressure needed to satisfy the flow requirements of the implement-based hydraulic loads (plus a given pressure margin), and Qₑ corresponds to the flow rate error or flow loss introduced due to the low system pressures.

The unknown parameters within the governing equation (i.e., the input flow rate, Qₘ, and the line capacitance, Kₗᵢₙₑ) can be approximated using an online parameter estimation methodology. For example, as indicated above, an ARIX (Auto Regressive Integrator with exogenous input) model structure can be used. In one embodiment, the governing equation (Equation 1) can be modeled as first-order difference equations using the ARIX model structure. For example, the governing equation can be rewritten in discrete time form (Equation 3) and then parameterized (Equation 4) as provided below:

$${p}_{p} ( {q}^{0} ) - {p}_{p} ( {q}^{- 1} ) = {T}_{s} \cdot {K}_{line} ( {Q}_{p} ( {q}^{- 1} ) - {Q}_{m} ( {q}^{- 1} ) ) \qquad ( 3 )$$

$${p}_{p} ( {q}^{0} ) - {p}_{p} ( {q}^{- 1} ) = {\hat{θ}}_{1} \cdot {β}_{p} ( {q}^{- 1} ) - {\hat{θ}}_{2} \qquad ( 4 )$$

wherein, pₚ(q⁰) corresponds to the current pump output pressure (e.g., as determined based on the data from the pressure sensor 122), pₚ(q⁻¹) corresponds to the previously measured pump output pressure (e.g., as determined based on the data from the pressure sensor 122 from the last time step), Tₛ corresponds to the time step or frequency interval at which the controller 120 calculates the modelled output pressure (i.e., a known value to the controller 120), Kₗᵢₙₑ corresponds to the line capacitance associated with the attached implement 12, Qₚ(q⁻¹) corresponds to previously determined pump output flow rate (e.g., as calculated based on the input signals described above), Qₘ(q⁻¹) corresponds to previously estimated pump output flow rate (e.g., the previous estimate from the last time step), \hat{θ}₁ corresponds the first estimated coefficient, βₚ(q⁻¹) corresponds to the previously measured pump fractional displacement (e.g., as determined based on the data from the displacement sensor 124 from the last time step), and \hat{θ}₂ corresponds to the second estimated coefficient.

As noted above in Equations 3 and 4, the product of the first estimated coefficient, \hat{θ}₁, and the previously measured pump fractional displacement, βₚ (q⁻¹), generally approximates the product of the line capacitance, Kₗᵢₙₑ, and the output flow rate, Qₚ, from the system's governing equation, while the second estimated coefficient, \hat{θ}₂, generally approximates the product of the line capacitance, Kₗᵢₙₑ, and the implement input flow rate, Qₘ, from the system's governing equation. As such, the above-referenced parameter estimation methodology may allow for both the line capacitance, Kₗᵢₙₑ, and the implement input flow rate, Qₘ, to be estimated or approximated. The coefficients, \hat{θ}₁, \hat{θ}₂, are generally estimated using a recursive least squares algorithm.

A general parameter estimation structure can be represented below using the following equations (Equations 5, 6, and 7):

$$y ( t ) = {y}_{m} ( t ) + e ( t ) \qquad ( 5 )$$

$${y}_{m} ( t ) = {{ϕ}_{m} ( t )}^{T} \hat{θ} ( t ) \qquad ( 6 )$$

$$y ( t ) = {φ ( t )}^{T} θ = {{φ}_{m} ( t )}^{T} \hat{θ} ( t ) + Δ ( t ) + δ ( t ) \qquad ( 7 )$$

wherein, y(t) corresponds to the actual system output (e.g., the measured pump output pressure or output pressure rate), yₘ(t) corresponds to the model system output (e.g., the predicted or modeled pump output pressure or change in pump output pressure), e(t) corresponds to the system's prediction error, φ(t)^{T} corresponds to the actual system dynamics within the hydraulic system (e.g., hydraulic line capacitance), θ corresponds to the system parameter coefficients, φₘ(t)^{T} corresponds to the modeled system dynamics within the hydraulic system (e.g., hydraulic line capacitance), \hat{θ}(t) corresponds to the estimated parameter coefficients, Δ(t) corresponds to the system error introduced due to the model structure, and δ(t) corresponds to the error introduced due to noise and other disturbances. By combining Equations 5 through 7, the system's prediction error, e(t), can be generally expressed according to the following equation (Equation 8):

$$e ( t ) = {φ ( t )}^{T} θ - {{φ}_{m} ( t )}^{T} \hat{θ} ( t ) + Δ ( t ) + δ ( t ) \qquad ( 8 )$$

Assuming no model structure or system error (i.e., Δ(t) is equal to zero) such that there are no uncaptured dynamics or functions and, thus, the actual system dynamics, φ(t)^{T}, are equal to the modeled system dynamics, φₘ (t)^{T}, Equation 8 can be rewritten (Equation 9) and further simplified (Equation 10) as set forth below by substituting a generic term, \tilde{θ}, for the parameter estimation error represented by the expression (θ−\hat{θ}(t)):

$$e ( t ) = {φ ( t )}^{T} ( θ - \hat{θ} ( t ) ) + δ ( t ) \qquad ( 9 )$$

$$e ( t ) = {φ ( t )}^{T} \tilde{θ} + δ ( t ) \qquad ( 10 )$$

In view of Equation 10 and again assuming no model structure or system error, the parameter estimation error, \tilde{θ}, will converge to zero over time, which essentially reduces the prediction error, e(t), to the white noise within the system (i.e., δ(t)). However, if system error exists, the parameter estimation error, \tilde{θ}, will not converge to zero and, thus, the prediction error, e(t), will remain a function of the system input or pump input parameter (i.e., φ(t)^{T}). In this regard, as indicated above, the model assumes that the input flow rate, Qₘ, to the implement 12 is equal to the commanded flow rate, Q_{cmd}, which intentionally introduces a structural or system error within the model when the pump output pressure is less than the minimum target output pressure required to satisfy the flow requirements of the implement-based hydraulic loads. In other words, the system error, Δ(t), only appears when the pump output pressure is less than the minimum required pump output pressure and, thus, the prediction error is correlated to the pump input parameter when the pump output pressure is less than the minimum target output pressure.

Accordingly, as indicated above, the cross-correlation between the prediction error and the pump input parameter (e.g., the pump fractional displacement) can be used to predict when the pump output pressure is insufficient to satisfy the flow requirements of the implement-based hydraulic loads without requiring implement-side sensors or any other related communication between the vehicle-side and implement-side controllers 120, 132. Specifically, little to no cross-correlation will be present between the prediction error and the pump input parameter when the pump output pressure is sufficiently high, as the prediction error will only be equal to the white noise within the system. However, a stronger or increased cross-correlation will exist between the prediction error and the pump input parameter with insufficient pump output pressures. Accordingly, the controller 120 can infer the sufficiency of the pump output pressure based on the strength of the cross-correlation, thereby allowing the controller 120 to continuously seek the minimum output pressure required to satisfy the flow requirements of the implement-based hydraulic loads. For instance, as will be described below, the logic implemented by the pressure control module 146 of the controller 120 may be adapted to analyze the cross-correlation between the prediction error and the pump input parameter and determine what adjustments need to be made to the pump output pressure to drive the system towards the minimum target output pressure, such as by decreasing the pump output pressure when the cross-correlation is low and increasing the pump output pressure when the cross-correlation is high).

Referring now to FIG. 4, a schematic view of a flow diagram providing one embodiment of pressure control logic 200 that can be executed by the vehicle-based controller 120 (e.g., via the pressure control module 146) is illustrated in accordance with aspects of the present subject matter. As shown, the pressure control logic 200 generally utilizes a decision state machine 202 (referred to hereinafter as the “DSM block 202”) to determine whether the pump output pressure needs to be adjusted (e.g., stepped down or stepped up). In several embodiments, such determinations may be based on one or more moving averages of the cross-correlation between the prediction error and the pump input parameter (e.g., in this case, the pump fractional displacement). For instance, in the illustrated embodiment, the pressure control logic 200 receives one or more modelled inputs 204, such as the cross-correlation, β⊗e, between the prediction error and the pump fractional displacement and the estimated output rate, Qₚ, of the pump 102, as well as one or more measured inputs 206 (e.g., the pump output pressure, pₚ). Based on these inputs (and as represented by block 208 in FIG. 4), the controller 120 is configured to calculate a short moving average (SMA) of the cross-correlation between the prediction error and the pump fractional displacement (e.g., across a time period or “control interval” defined between pressure adjustment decisions made by the DSM block 202).

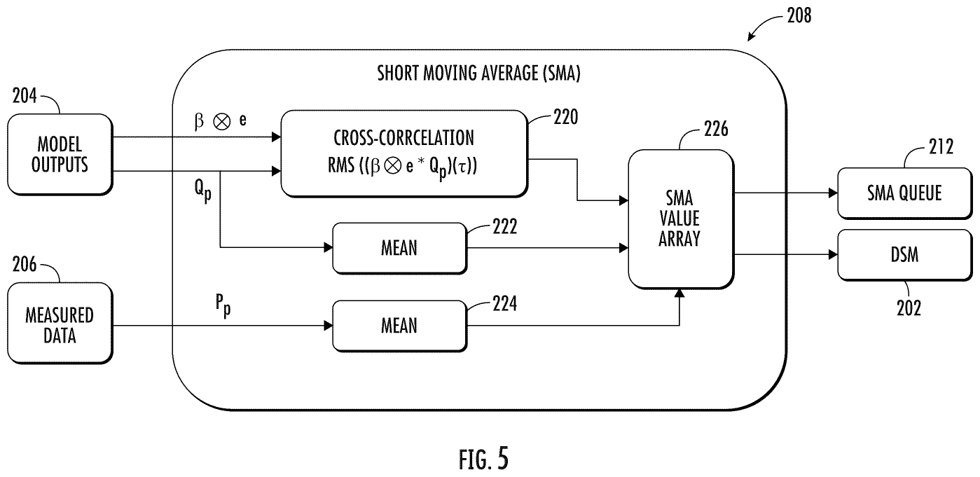

An example of the operation of the SMA block 208 is shown schematically in FIG. 5. As illustrated in FIG. 5, the modelled/measured inputs 204, 206 allow the controller 120 to calculate an SMA value for the cross-correlation between the prediction error and the pump input parameter across the time interval (e.g., at box 220), such as by calculating a root mean square (RMS) value of the cross-correlation values across the control interval (e.g., RMS((β⊗e*Qₚ)(τ))). In addition, the controller 120 may be configured to calculate mean values for the estimated output rate, Qₚ, of the pump 102 and the measured output pressure, pₚ, of the pump 102 across the control interval (e.g., at boxes 222, 224). These calculated values for the current control interval (i.e., the SMA value for the cross-correlation, the mean estimated output flow rate, and the mean pump pressure output) may then be arranged within a SMA value array (e.g., at box 226) that is output to the DSM block 202. Additionally, as will be described below, the SMA value array may also be queued within the controller's memory (e.g., at box 212) to allow a determination to be made as to whether the associated SMA value for the cross-correlation will be incorporated into a long moving average (LMA) of “safe values” corresponding to instances in which the controller 120 has determined that the pump output pressure is sufficient to meet the hydraulic requirements of the implement-based hydraulic loads.

Referring back to FIG. 4, in addition to the SMA value array, the DSM block 202 is configured to receive a long moving average (LMA) value array from an LMA block 210 corresponding to a longer-term history of the data taken from the SMA block 208 (i.e., the SMA value for the cross-correlation, the mean estimated output flow rate, and the mean pump pressure output). However, in several embodiments, the pressure control logic 200 is designed such that the LMA value array only incorporates data from the SMA block 208 to the extent that the SMA data is reflective of instances in which the controller 120 determined that the pump output pressure was sufficient to meet the hydraulic requirements of the implement-based hydraulic loads. Thus, as shown in FIG. 4, the LMA block 210 may be configured to receive state information from the DSM block 202 indicative of whether DSM block 202 determined whether a pressure increase (thereby indicating that the pump output pressure is currently insufficient) was appropriate based on the current SMA value array received from the SMA block 208. To the extent that a pressure increase is being recommended or commanded by the DSM block 202, the SMA value array associated with making such determination is not incorporated into the LMA value array. However, to the extent that a pressure drop is being recommended or commanded by the DSM block 202 (or the DSM block 202 recommends or commands that the output pressure be maintained at its current pressure), the SMA value array associated with making such determination is incorporated into the LMA value array.

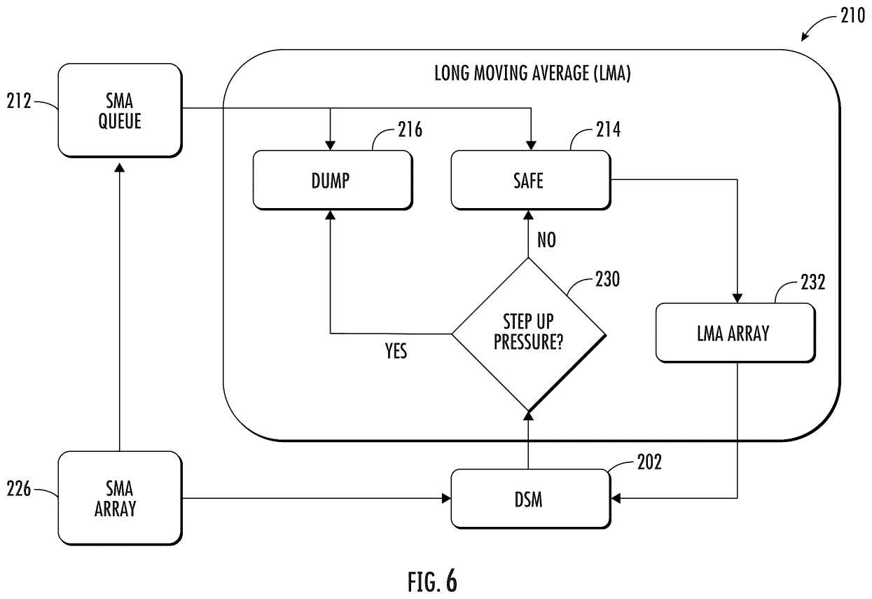

An example of the operation of the LMA block 210 is shown schematically in FIG. 6. As illustrated in FIG. 6, the SMA value array stored in the queue (i.e., SMA queue 212) is input into two separate blocks, namely a “SAFE” block 214 and a “DUMP” block 216. As indicated above, this SMA value array is also input into the DSM block 202 to determine whether the output pressure of the pump should be adjusted. As shown in FIG. 6, if, based on the SMA value array input into the DSM block 202 for the current control interval, the DSM block 202 determines (e.g., at block 230) that a step-up or increase in pressure is needed (i.e., thereby indicating that the current output pressure is insufficient), the SMA value array is “dumped” or otherwise deleted or ignored. However, if the DSM block 202 determines that a step-up or increase in pressure is not required (i.e., thereby indicating that the current output pressure is sufficient), the SMA value array is deemed “safe” or good and the SMA value array is incorporated into the LMA value array (e.g., as represented by block 232) as an update to the long-term moving average associated therewith.

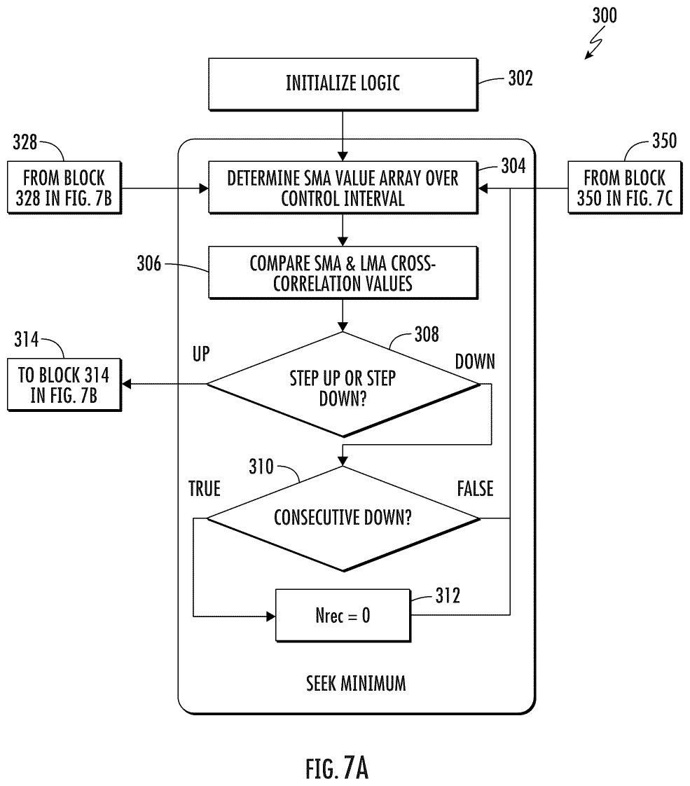

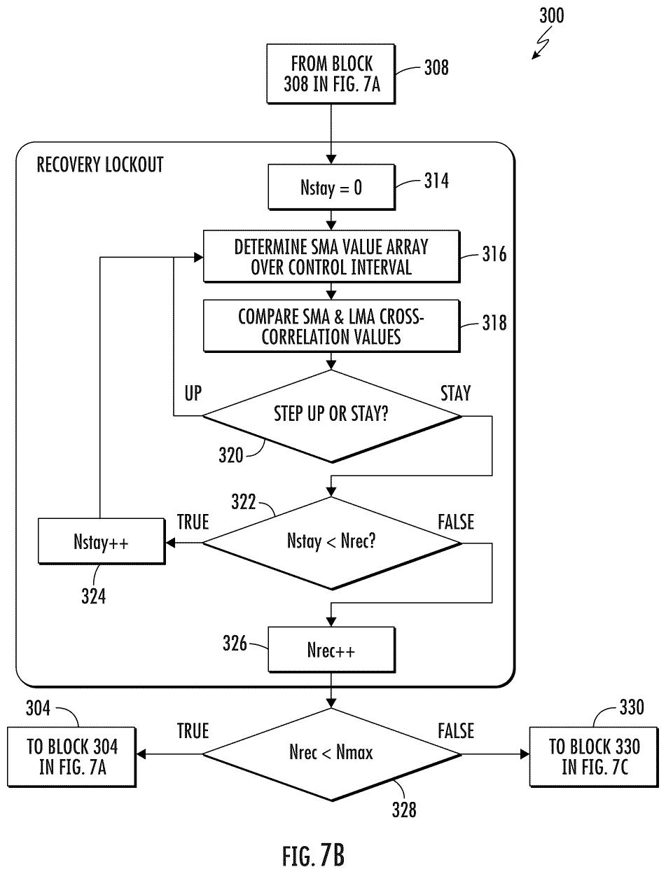

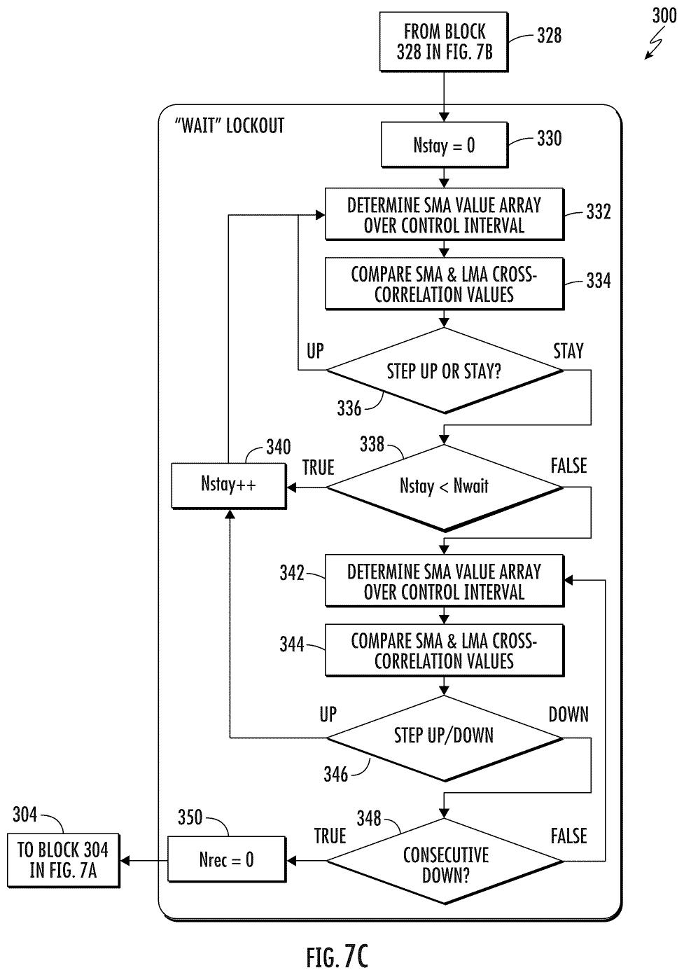

Referring briefly now to FIGS. 7A-7C, an example flow diagram representing one embodiment of control logic 300 associated with the operation of the DSM block 202 shown in FIG. 4 is illustrated in accordance with aspects of the present subject matter. As indicated above, the DSM block 202 is configured to determine whether the pump output pressure needs to be adjusted (e.g., stepped down or stepped up) based on one or more moving averages of the cross-correlation between the prediction error and the pump input parameter (e.g., in this case, the pump fractional displacement). For example, as will be described below, the DSM block 202 may be configured to compare the SMA and LMA cross-correlation values provided by the SMA and LMA blocks 208, 210 to assess whether the current or present cross-correlation between the prediction error and the pump fractional displacement (as represented by the SMA correlation value) is indicative of the pump output pressure being sufficient or insufficient to satisfy the flow requirements of the implement-based hydraulic loads. Specifically, as noted above, the LMA cross-correlation value may, in several embodiments, be calculated using “safe” values corresponding to instances in which the controller 120 has determined that the pump output pressure is sufficient to meet the hydraulic requirements of the implement-based hydraulic loads. As such, any significant deviation of the SMA cross-correlation value from the LMA cross-correlation value (e.g., above a threshold amount defined relative to the LMA cross-correlation value) will generally be indicative of the pump output pressure being too low. For instance, since stronger or higher cross-correlation values are indicative of the output pressure being too low, a deviation threshold may be defined that is equal to a given percentage or offset from the LMA cross-correlation value (e.g., an amount equal to 5% or 10% of the LMA cross-correlation value). In such instance, in the event the SMA cross-correlation value exceeds the LMA cross-correlation value by the deviation threshold, it may be inferred or determined that the pump output pressure is currently insufficient to meet the hydraulic requirements of the implement-based hydraulic loads.

FIG. 7A generally illustrates a “SEEK MINIMUM” phase or portion of the control logic 300, wherein the controller 120 seeks to find the minimum target output pressure. As shown in FIG. 7A, at (302), during initialization of the DSM logic 300, the controller 120 may be configured to access the historical data stored within the controller's memory, particularly the LMA value array including the current LMA cross-correlation value. Additionally, at initialization, the pump operation may be initialized by setting the pump output pressure to a given “safe” value, such as the maximum output pressure of the pump 102 or some other heightened output pressure. This increased or heightened output pressure (relative to the minimum target output pressure being sought by the controller 120) ensures that the system initializes with a sufficient starting output pressure, thereby allowing the control logic 300 to begin to “seek down” towards the minimum target output pressure by reducing the pump output pressure in a decremental manner. In doing so, the controller 120 may be allowed to collect additional “safe values” for the cross-correlation between the prediction error and the pump fractional displacement, thereby allowing the LMA cross-correlation value to be updated.

Additionally, following initialization, the controller 120 may, at (304), be configured to wait a given delay period or control interval while sufficient input data is being collected to allow a new or initial SMA value array to be calculated by the controller 120. For instance, as described above with reference to FIG. 5, the controller 120 system may utilize modelled inputs 204 (e.g., the cross-correlation between the prediction error and the pump fractional displacement along with the estimated output rate of the pump 102) to calculate an SMA value for the cross-correlation between the prediction error and the pump fractional displacement across the control interval, such as by calculating a root mean square (RMS) value of the cross-correlation values across the control interval. In several embodiments, the control interval may be selected based on the desired frequency at which pressure adjustments are to be made within the system. In this regard, it may be desirable to set the control interval to be a sufficient time period (e.g., 2 to 6 seconds) to allow a more steady-state SMA value array to be determined.

Referring still to FIG. 7A, at (306), the controller 120 may be configured to compare the SMA cross-correlation value determined at (304) with the LMA cross-correlation value stored within the controller's memory. As indicated above, in several embodiments, the SMA cross-correlation value may be compared with the LMA cross-correlation value to determine if the SMA cross-correlation value differs from the LMA cross-correlation value by a given threshold amount (e.g., a deviation threshold of 5% or 10% of the LMA cross-correlation value). This comparison allows the controller 120 to determine what, if any, pressure adjustments should be made to the pump output pressure. Specifically, if the comparison between the SMA cross-correlation value and LMA cross-correlation value indicates that the SMA cross-correlation value is not greater than the LMA cross-correlation value by the specified deviation threshold (thereby indicating that the pump output pressure is currently sufficient to meet the demands of the system), the controller 120 may, at (308), determine that a “step down” or reduction in pump output pressure can be made to seek towards a minimum target output pressure for the pump 102 given the demands of the system. In contrast, if the comparison between the SMA cross-correlation value and LMA cross-correlation value indicates that the SMA cross-correlation value is greater than the LMA cross-correlation value by the specified deviation threshold (thereby indicating that the pump output pressure is currently insufficient to meet the demands of the system), the controller 120 may, at (308), determine that a “step up” or increase in pump output pressure should be made to ensure that the hydraulic demands of the system can be satisfied.

Regardless of whether a “step down” or “step up” decision is made at (308), the controller 120 determines a new nominal output pressure setpoint for the pump 102. For instance, the controller 120 may be configured to decrement or increment the current nominal output pressure setpoint for the pump 102 by a given or predetermined amount depending on whether a respective “step down” or “step up” decision has been made. As will be described later with reference to FIG. 4, the updated nominal output pressure setpoint may then be perturbed (e.g., at perturbation block 218 shown in FIG. 4) to generate a final output pressure command that can be sent to the pump 102 to adjust its output pressure accordingly.

As shown in FIG. 7A, if a “step down” decision is made at (308), the controller 120, at (310), is configured to determine whether consecutive “step down” decisions have been made by the controller 120 (i.e., was the previous decision also a “step down” decision). If the controller 120 determines that consecutive “step down” decisions have not been made (e.g., the previous decision was a “step up” decision), the DSM logic 300 simply loops back to (304), at which point the controller 120 again calculates a new SMA value array across the predetermined control interval or delay period (e.g., 2 to 6 seconds). If the controller 120, instead, determines that consecutive “step down” decisions have been made (e.g., the previous decision was a “step down” decision), the DSM logic 300, at (312), resets a “Recovery Count” value (Nrec) to zero. As will be described below with reference to FIG. 7B, this “Recovery Count” value may be used within a “RECOVERY LOCKOUT” phase or portion of the control logic 300 to determine whether by the DSM logic 300 can proceed following a given number of “stay” decisions in which the output pressure of the pump 102 has been maintained at is previous output pressure (e.g., as opposed to a “step up” or “step down” decision). For instance, the “Recovery Count” value may correspond to the number of times that the controller 120 has transitions between the “SEEK MINIMUM” and “RECOVERY LOCKOUT” portions of the control logic 300 without making consecutive “step down” decisions. Upon resetting the “Recovery Count” value to zero at (312), the DSM logic 300 loops back to (304) to calculate a new SMA cross-correlation value. This newly calculated value is then compared (at (306)) to the LMA cross-correlation value to determine the next pressure adjustment to be made. As indicated above, the pump 102 may be initialized at a heightened pump output pressure such that numerous reductions or “step down” decisions may be made before the output pressure reaches or drops below the minimum target output pressure for the system.

Still referring to FIG. 7A, if a “step up” decision is made at (308), the controller 120 is configured to execute a “RECOVERY LOCKOUT” phase or portion of the control logic 300, which is illustrated in FIG. 7B. Specifically, upon making the “step up” decision at (308), the logic 300 transitions to block (314) in FIG. 7B, at which point the controller 120 is configured to reset a “Recovery Stay” value (Nstay) to zero. As will be described below, this “Recovery Stay” value is used to determine whether the controller 120 should remain within the “RECOVERY LOCKOUT” phase or portion of the control logic 300 or potentially transition to another phase or portion of the logic 300 (e.g., the “SEEK MINIMUM” portion of FIG. 7A or the “WAIT LOCKOUT” portion of FIG. 7C). As shown in FIG. 7B, upon resetting the “Recovery Stay” value to zero, the controller 120 is configured, at (316), to calculate a new SMA value array across the predetermined control interval or delay period (e.g., 2 to 6 seconds). The newly calculated SMA cross-correlation value is then compared to the current LMA cross-correlation value at (318) to determine whether a further increase in the output pressure should be made or whether the output pressure for the pump 102 should be maintained at its current pressure setting.

At (320), if the comparison between the new SMA cross-correlation value and LMA cross-correlation value indicates that the SMA cross-correlation value is still greater than the LMA cross-correlation value by the specified deviation threshold (thereby indicating that the pump output pressure is still insufficient to meet the demands of the system), the controller 120 may determine that a further “step up” or increase in the pump output pressure should be made. In such instance, as shown in FIG. 7B, the DSM logic 300 simply loops back to (316), at which point the controller 120 again calculates a new SMA value array across the predetermined control interval or delay period (e.g., 2 to 6 seconds) and subsequently compares the newly calculated SMA cross-correlation value to the LMA cross-correlation value. In contrast, if the comparison between the SMA cross-correlation value and LMA cross-correlation value at (318) indicates that the SMA cross-correlation value is no longer greater than the LMA cross-correlation value by the specified deviation threshold (thereby indicating that the pump output pressure is now sufficient to meet the demands of the system), the controller 120 may determine that the pump output pressure may be maintained at its current state (i.e., a “stay” decision). Regardless, based on the decision made at (320), the controller 120 will determine a new or updated nominal output pressure setpoint for the pump 102. For instance, the controller 120 may be configured to increment the current nominal output pressure setpoint for the pump 102 by a given or predetermined amount when a “step up” decision has been made. Alternatively, if a decision has been made to maintain the pump output pressure at its current level, the new or updated nominal output pressure setpoint may simply correspond to the prior nominal output pressure setpoint. As noted above, the nominal output pressure setpoint determined by the controller may then be perturbed (e.g., at the perturbation block 218 in FIG. 4) to generate a final output pressure command that can be sent to the pump 102 to provide the desired output pressure.

As shown in FIG. 7B, when a “stay” decision is made at (320), the controller 120 is configured, at (322), to determine whether the “Recovery Stay” value (Nstay) is less than the “Recovery Count” value (Nrec). If the “Recovery Stay” value is less than the “Recovery Count” value at (322), the controller 120 is configured, at (324), to increment or increase the “Recovery Stay” value (Nstay) by one and then loop back to (316), at which point the controller 120 again calculates a new SMA value array across the predetermined control interval or delay period (e.g., 2 to 6 seconds) and subsequently compares the newly calculated SMA cross-correlation value to the LMA cross-correlation value. If, instead, the “Recovery Stay” value is not less than the “Recovery Count” value at (322), the controller 120 is configured, at (326), to increment or increase the “Recovery Count” value (Nrec) by one. This incremented value is then compared, at (328), to a “Recovery Max” value (Nmax) corresponding to a predetermined value stored within the memory of the controller 120. As shown in FIG. 7B, if the “Recovery Count” value (Nrec) is less than the “Recovery Max” value (Nmax), the control logic 300 may simply loop back to (304) of the “SEEK MINIMUM” portion of the logic 300,), at which point the controller 120 calculates a new SMA value array across the predetermined control interval or delay period (e.g., 2 to 6 seconds) and subsequently compares the newly calculated SMA cross-correlation value to the LMA cross-correlation value.

Alternatively, if the “Recovery Count” value (Nrec) is not less than the “Recovery Max” value (Nmax) (e.g., the incremented value is now equal to the max value), the controller 120 is configured to execute a “WAIT LOCKOUT” phase or portion of the control logic 300, which is illustrated in FIG. 7C. Specifically, upon determining that the “Recovery Count” value (Nrec) is not less than the “Recovery Max” value (Nmax) at (328), the logic 300 transitions to block (330) in FIG. 7C, at which point the controller 120 is configured to reset the “Recovery Stay” value (Nstay) to zero. As shown in FIG. 7C, upon resetting the “Recovery Stay” value to zero, the controller 120 is configured, at (332), to calculate a new SMA value array across the predetermined control interval or delay period (e.g., 2 to 6 seconds). The newly calculated SMA cross-correlation value is then compared to the current LMA cross-correlation value at (334) to determine whether a further increase in the output pressure should be made or whether the output pressure for the pump 102 should be maintained at its current pressure setting.

At (336), if the comparison between the new SMA cross-correlation value and LMA cross-correlation value indicates that the SMA cross-correlation value is still greater than the LMA cross-correlation value by the specified deviation threshold (thereby indicating that the pump output pressure is still insufficient to meet the demands of the system), the controller 120 may determine that a further “step up” or increase in the pump output pressure should be made. In such instance, as shown in FIG. 7C, the DSM logic 300 simply loops back to (332), at which point the controller 120 again calculates a new SMA value array across the predetermined control interval or delay period (e.g., 2 to 6 seconds) and subsequently compares the newly calculated SMA cross-correlation value to the LMA cross-correlation value. In contrast, if the comparison between the SMA cross-correlation value and LMA cross-correlation value at (336) indicates that the SMA cross-correlation value is no longer greater than the LMA cross-correlation value by the specified deviation threshold (thereby indicating that the pump output pressure is now sufficient to meet the demands of the system), the controller 120 may determine that the pump output pressure may be maintained at its current state (i.e., a “stay” decision). Regardless, based on the decision made at (336), the controller 120 will determine a new or updated nominal output pressure setpoint for the pump 102. For instance, the controller 120 may be configured to increment the current nominal output pressure setpoint for the pump 102 by a given or predetermined amount when a “step up” decision has been made. Alternatively, if a decision has been made to maintain the pump output pressure at its current level, the new or updated nominal output pressure setpoint may simply correspond to the prior nominal output pressure setpoint. As noted above, the nominal output pressure setpoint determined by the controller may then be perturbed (e.g., at the perturbation block 218 in FIG. 4) to generate a final output pressure command that can be sent to the pump 102 to provide the desired output pressure.

As shown in FIG. 7C, when a “stay” decision is made at (336), the controller 120 is configured, at (338), to determine whether the “Recovery Stay” value (Nstay) is less than a “Wait Threshold” value (Nwait) corresponding to a predetermined threshold or value stored within the controller's memory. If the “Recovery Stay” value is less than the “Wait Threshold” value at (338), the controller 120 is configured, at (340), to increment or increase the “Recovery Stay” value (Nstay) by one and then loop back to (332), at which point the controller 120 again calculates a new SMA value array across the predetermined control interval or delay period (e.g., 2 to 6 seconds) and subsequently compares the newly calculated SMA cross-correlation value to the LMA cross-correlation value.

If, instead, the “Recovery Stay” value is not less than the “Wait Threshold” value at (336) (thereby indicating that the controller 120 has made a given number of consecutive “stay” decisions equal to the “Wait Threshold” value), the controller 120 is configured, at (342), to again calculate a new SMA value array across the predetermined control interval or delay period (e.g., 2 to 6 seconds) and subsequently compare, at (344), the newly calculated SMA cross-correlation value to the LMA cross-correlation value. If the comparison between the SMA cross-correlation value and LMA cross-correlation value indicates that the SMA cross-correlation value is greater than the LMA cross-correlation value by the specified deviation threshold, the controller 120 may, at (346), make a “step up” decision, in which case the controller 120 is configured to loop back to block (340) to increment the “Recovery Stay” value (Nstay) by one before proceeding to block (332) to calculate a new SMA value array for the next control interval. In contrast, if the comparison between the SMA cross-correlation value and LMA cross-correlation value indicates that the SMA cross-correlation value is not greater than the LMA cross-correlation value by the specified deviation threshold, the controller 120 may, at (346), make a “step down” decision, in which case the controller 120, at (348), is configured to determine whether consecutive “step down” decisions have been made by the controller 120 (i.e., was the previous decision also a “step down” decision). If the controller 120 determines that consecutive “step down” decisions have not been made (e.g., the previous decision was a “step up” decision), the DSM logic 300 simply loops back to (342), at which point the controller 120 again calculates a new SMA value array across the next control interval. If the controller 120, instead, determines that consecutive “step down” decisions have been made (e.g., the previous decision was a “step down” decision), the DSM logic 300, at (350), resets the “Recovery Count” value (Nrec) to zero. Upon resetting the “Recovery Count” value to zero at (350), the controller 120 loops back to (304) within the “SEEK MINIMUM” portion of the logic 300, at which point the controller 120 calculates a new SMA cross-correlation value.

Regardless of whether a “step down” or “step up” decision is made at (346), the controller 120 determines a new nominal output pressure setpoint for the pump 102. For instance, the controller 120 may be configured to decrement or increment the current nominal output pressure setpoint for the pump 102 by a given or predetermined amount depending on whether a respective “step down” or “step up” decision has been made. As noted above, the nominal output pressure setpoint determined by the controller may then be perturbed (e.g., at the perturbation block 218 in FIG. 4) to generate a final output pressure command that can be sent to the pump 102 to provide the desired output pressure.

Referring back to FIG. 4, as indicated above, the nominal output pressure setpoint, P_{p,nom}, provided by the DSM block 202 may be perturbed (e.g., at perturbation block 218) to generate a final output pressure command, P_{p,cmd}, that can be sent to the pump 102 to command the desired output pressure. Specifically, in several embodiments, the nominal output pressure setpoint may be modified by a small perturbation signal to create a persistent excitation within the commanded pressure signal. For instance, in one embodiment, a pseudo-square wave signal may be used to modify the nominal output pressure setpoint (e.g., by summing the nominal output pressure setpoint with the pseudo-square wave signal). In such an embodiment, the amplitude of the pseudo-square wave signal may be relatively small (e.g., 5 bar pressure) to create a small, but persistent excitation within the commanded signal.

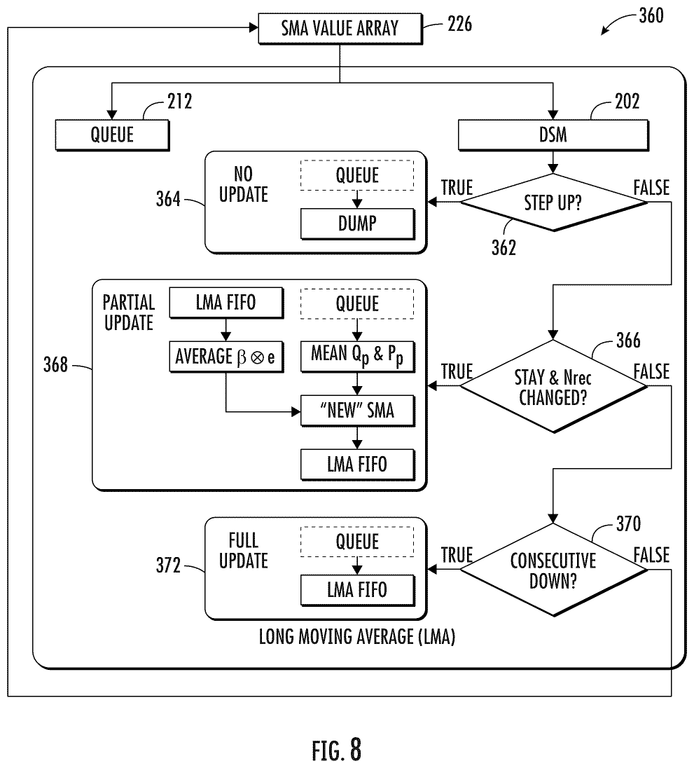

Referring now to FIG. 8, a schematic view of example control logic 360 suitable for use with the long-moving average (LMA) block 210 shown in FIG. 4 when executing the DSM logic 300 of FIGS. 7A-C is illustrated in accordance with aspects of the present subject matter. As shown in FIG. 8 (and as generically described above with reference to FIG. 6), the SMA value array 226 calculated by the controller 120 may be input into both a queue (i.e., SMA queue 212) and the DSM block 202. As indicated above, the DSM block 202 is configured to make determinations regarding pressure adjustments to be made to the output pressure of the pump 102, i.e., a “step up” decision, a “step down” decision, or a “stay” decision. As shown in FIG. 8, the control logic 360 utilizes the decisions made by DSM block 202 to determine whether to update the LMA value array (and to what extent the LMA value array should be updated). Specifically, as shown in the illustrated embodiment, the controller 120 is configured, at (362), to initially determine whether the decision made by the DSM block 202 was a “step up” decision. If the output from the DMS block 202 corresponded to a “step up” decision, then the controller 120 is configured to delete/dump or ignore the SMA value array stored in the queue 212 (e.g., as represented by block (364)), in which case such data is not used to update the LMA value array.

If the decision made by the DSM block 202 was not a “step up” decision, the controller, at (366), is configured to determine whether the decision made by the DSM block 202 was a “stay” decision that resulted in the “Recovery Count” value (Nrec) being changed. In the event the output from the DMS block 202 corresponded to a “stay” decision resulting in the “Recovery Count” value being changed, the controller 120 is configured to partially update the LMA value array based on the SMA value array stored in the queue 212 (e.g., as represented by block (368)). Specifically, as shown in FIG. 8 in block (368), the controller 120 may be configured to use the queued data to calculate new mean values for the estimated output flow rate and the pump pressure output, which can then be used to create an updated or “new” SMA value array. However, as shown in block (368), the “new” SMA value array utilizes the existing average cross-correlation between the prediction error and the fractional pump displacement from the LMA value array (as opposed to the cross-correlation value initially included within the SMA value array stored in the queue 212). The resulting “new” SMA value array (including the updated mean values for estimated output flow rate and the pump pressure output and the previous average cross-correlation value stored within the LMA value array) is then incorporated into the LMA to determine an updated LMA value array.

Referring still to FIG. 8, if the decision made by the DSM block 202 was not either a “step up” decision or a “stay” decision that resulted in the “Recovery Count” value (Nrec) being changed, the controller, at (370), is configured to determine whether the DSM block 202 has made consecutive “step down” decisions (i.e., both the current decision being evaluated and the former decision were both “step down” decisions). In the event the DMS block 202 has, in fact, made consecutive “step down” decisions, the controller 120 is configured to fully update the LMA value array based on the SMA value array stored in the queue 212 (e.g., as represented by block (372)). Specifically, the controller 120 is configured to utilize the entirety of the SMA value array associated with the immediately prior “step down” decision to calculate or determine an updated LMA value array. In contrast, if the DMS block 202 has not made consecutive “step down” decisions (e.g., if the current “step down” decision followed a “stay” decision or a “step down” decision), the control logic 360 loops back to block 226 to allow for the calculation of a new SMA value array. In such instance, the former SMA value array may be maintained in the queue 212 until the control logic 360 is again executed following the new pressure adjustment decision made by the DMS block 202.

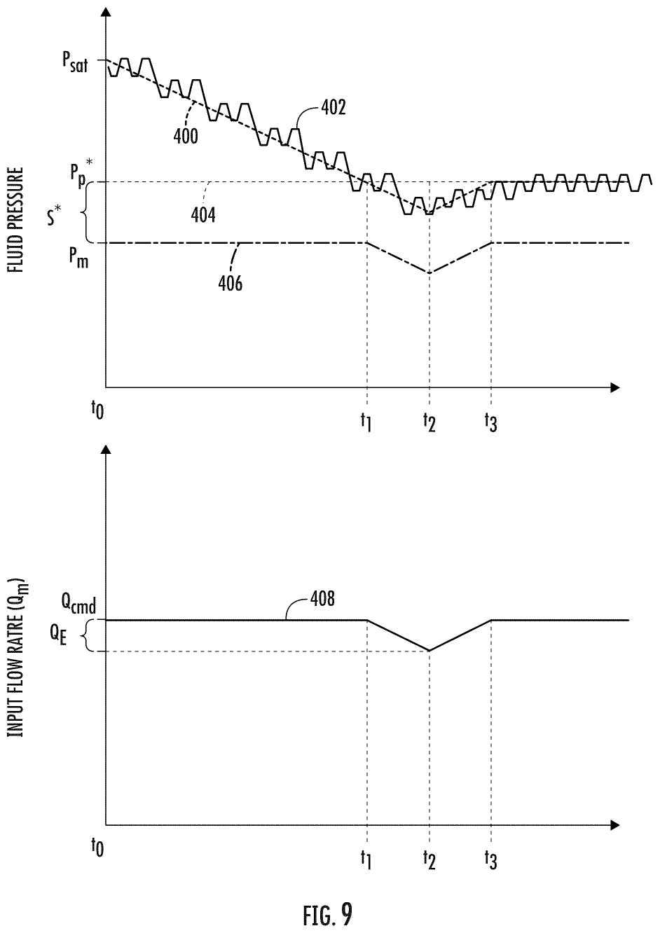

Referring now to FIG. 9, an example data series is illustrated that charts system pressures (e.g., pump output pressure, Pₚ, and input pressure, Pₘ) as well as the input flow rate, Qₘ, to the implement 12 over time during execution of the control logic 200, 300 described above. Specifically, the upper data series charts the output pressure, Pₚ, of the pump 102 (indicated by dashed line 400 with a perturbation signal, e.g., a pseudo-square wave signal 402, superimposed thereon to represent the excitation applied to the commanded pressure) relative to the minimum target output pressure being sought by the controller 120 (indicated by dashed line 404) as well as the input pressure, Pₘ, to the implement 12 (indicated by dash-dot line 406). As shown in FIG. 9, the minimum target output pressure 404 is represented as a value equal to the input pressure, Pₘ, to the implement 12 plus a given pressure margin or offset, s*. The lower data series charts the corresponding input flow rate, Qₘ, to the implement 12 (i.e., indicated by solid line 408) as the controller 120 adjusts the pump output pressure 400 while it is actively seeking the minimum target output pressure 404. As indicated above, given that the input pressure 406 is not known or monitored by the controller 120 and the input flow rate 408 to the implement 12 is being estimated by the controller 120 using the above-described parameter estimation methodology (and in view of the system assumption for the input flow rate 408 that introduces a prediction error into the model outputs determined by the controller 120), the controller 120 utilizes the cross-correlation between the prediction error and the pump fractional displacement to infer when the pump output pressure 400 is insufficient to meet the hydraulic requirements of the implement.

As shown in FIG. 9, at the initialization time (t₀), the pump output pressure 400 is initially set to some heightened output pressure (e.g., a saturation pressure, Pₛₐₜ) that is selected to be higher than the expected or anticipated value for the minimum target output pressure 404 being sought by the controller 120. Since this initial output pressure is higher than the minimum target output pressure 404 (and, thus, sufficient to satisfy the hydraulic demands of the implement), the input flow rate 408 to the implement 12 is generally equal to the commanded input flow rate, Q_{cmd}. Following initialization of the above-described control logic 200, 300, the controller 120 begins to “step down” or reduce the pump output pressure 400 in an attempt to seek or find the minimum target output pressure 404. As described above with reference to the control logic 300 of FIG. 7, the controller 120 may cycle through multiple control intervals across which modelled/measured inputs are collected to allow new SMA cross-correlation values to be calculated, which may then be compared to the LMA cross-correlation value to determine whether to “step down” or “step up” the pump output pressure. In this regard, the data charted across the time period extending in FIG. 9 from the initialization time (t₀) to time (t₁) represents multiple control intervals across which the controller 120 decreased the output pressure 400 of the pump 102 as it attempts to seek or find the minimum target output pressure 404. As shown, during this time period, the input flow rate 408 to the implement 12 remains stable at the commanded input flow rate, Q_{cmd}, given that the pump output pressure 400 remains above the minimum target output pressure 402.

As shown in FIG. 9, at time (t₁), the pump output pressure 400 has been reduced to the minimum target output pressure 404. However, given that the controller 120 is not actively monitoring the input flow rate 408 (or the input pressure 406) to the implement 12, the controller 120 is unaware, at time (t₁), that the minimum target output pressure 404 has been achieved. Rather, in accordance with aspects of the present subject matter, the controller 120 is adapted to detect such occurrences based on the cross-correlation between the system error and the pump fractional displacement. In this regard, as shown in FIG. 9, the control logic 200, 300 will cause the controller 120 to initially overshoot the minimum target output pressure 404 (e.g., by issuing a pressure output command at time (t₁) to further reduce the pump output pressure by the given step-down amount). This reduction in the pump output pressure 400 to a pressure below the minimum target output pressure 404 results in the input pressure 406 being diminished and a small flow disturbance in the input flow rate 408 to the implement 12 (e.g., as seen from time (t₁) to time (t₂)). For example, at time (t₂), the input flow rate 408 to the implement 12 is equal to the commanded flow rate, Q_{cmd}, less the flow rate error, Qₑ, introduced due to the low system pressures (see Equation 2 above).

Given that the system model assumes that the input flow rate 408 to the implement 12 is equal to the commanded flow rate, Q_{cmd}, at all times, the controller 120 is able to detect this disturbance in the flow rate 408 indirectly via the modelled prediction error (and, particularly, through the cross-correlation between the prediction error and the pump fractional displacement), which then leads to the controller 120 increasing the pump output pressure. For instance, as shown in FIG. 9, the controller 120 has increased the pump output pressure 400 (e.g., from time (t₂) to time (t₃)) back up to the minimum target output pressure 404. As a result of this “step-up” decision, the input flow rate 408 to the implement 12 has been restored (at time (t₃)) to the commanded flow rate, Q_{cmd}, at which point the cross-correlation between the prediction error and the pump fractional displacement will again be low or minimal (i.e., the difference between the SMA and LMA cross-correlation values will be less than the deviation threshold). As shown in FIG. 9, the controller 120 may then, for example, maintain the pump output pressure 400 at the minimum target output pressure 404 until a flow disturbance is again detected via the cross-correlation analysis.

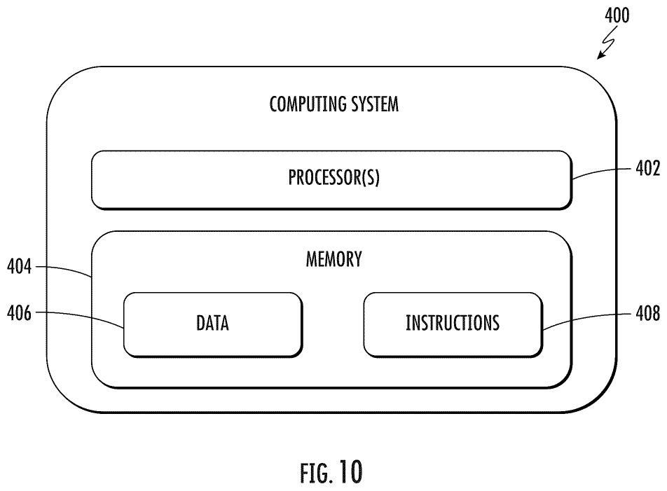

Referring now to FIG. 10, a schematic view of one embodiment of a computing system 400 that may be utilized to implement or execute one or more computer-implemented functions, including, for example, the control logic and/or methods described herein. In general, the computing system 400 may correspond to any suitable processor-based device(s), such as a computing device or any combination of computing devices. Thus, as shown in FIG. 10, the computing system 400 may generally include one or more processor(s) 402 and associated memory devices 404 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device 404 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device 404 may generally be configured to store information accessible to the processor(s) 402, including data 406 that can be retrieved, manipulated, created and/or stored by the processor(s) 402 and instructions 408 that can be executed by the processor(s) 402. In several embodiments, the data 406 may be stored in one or more databases. Additionally, in several embodiments, the instructions 408 stored within the memory device 404 of the computing system 400 may be executed by the processor(s) 402 to implement control logic, such as the control logic 200, 300 described above, and/or one or more modules, the modules 140, 142, 144, 146 described above.

The various functions of the computing system 400 may be performed by a single processor-based device or may be distributed across any number of processor-based devices, in which instance such devices may be considered to form part of the computing system 400. For instance, the functions of the computing system 400 may be distributed across multiple application-specific controllers or computing devices, such as a vehicle controller, an implement controller and/or the like. In this regard, it should be appreciated that one or both of the vehicle-side controller 120 and/or the implement side-controller 132 described herein may form all or part of the computing system 400.

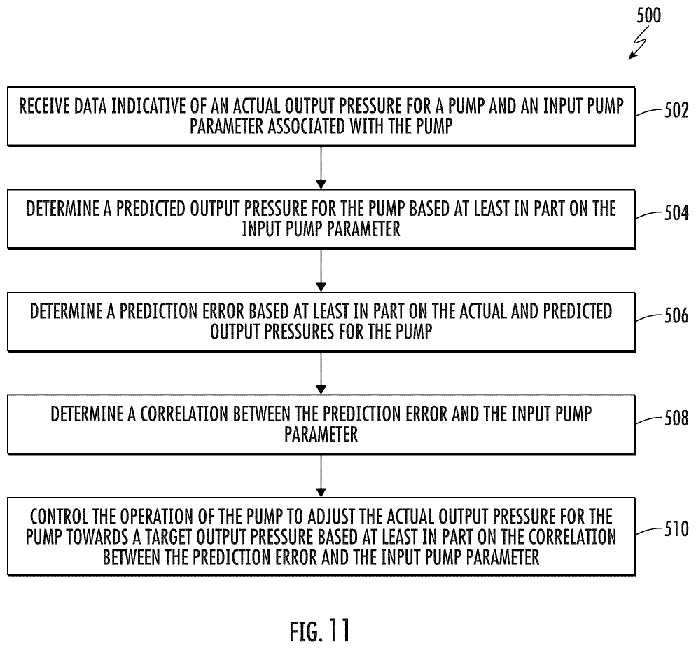

Referring now to FIG. 11, a flow diagram of one embodiment of a method 500 for controlling an operation of a pump of a work vehicle when supplying pressurized fluid to an implement coupled to the work vehicle is illustrated in accordance with aspects of the present subject matter. In general, the method 500 will be described herein with reference to the work vehicle 10, the implement 12, and the system 100 described above with reference to FIGS. 1-3. However, it should be appreciated by those of ordinary skill in the art that the disclosed method 500 may generally be implemented with any work vehicle having any suitable vehicle configuration, any implement having any suitable implement configuration, and/or within any system having any suitable system configuration. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 11, at (502), the method 500 may include receiving data indicative of an actual output pressure for a pump and an input pump parameter associated with the pump. For example, as indicated above, the computing system 400 (e.g., via the controller 120) may be configured to receive pressure data from the pressure sensor 122 indicative of the actual output pressure of the pump 102. Additionally, the computing system 400 may be configured to receive data indicative of an input pump parameter associated with the pump 102, such as data from the displacement sensor 124 indicative of pump fractional displacement.

Additionally, at (504), the method 500 may include determining a predicted output pressure for the pump based at least in part on the input pump parameter. As described above, the computing system 400 (e.g., via the controller 120) may be configured to input the pump fractional displacement into a system model that allows the computing system 400 to determine or predict a modelled output pressure for the pump.

Moreover, at (506), the method 500 may include determining a prediction error based at least in part on the actual and predicted output pressures for the pump. For example, as described above, the computing system 400 (e.g., via the controller 120) may be configured to calculate a prediction error for the system model based on the difference between the measured and modelled output pressures for the pump 102 (e.g., see Equation 5).

Referring still to FIG. 5, at (508), the method 500 may include determining a correlation between the prediction error and the input pump parameter. Specifically, as described above, the computing system 400 (e.g., via the controller 120) may be configured to calculate a cross-correlation between the prediction error and the input pump parameter (e.g., the pump fractional displacement), which can then be used to infer the sufficiency of the output pressure of the pump 102 with regard to satisfying the hydraulic demands of the implement 12. Alternatively, as indicated above, any other suitable mathematical correlation function or method may be used to establish or calculation a correlation between the prediction error and the input pump parameter, such as neural networks, fuzzy logic, etc.

Additionally, at (510), the method 500 may include controlling the operation of the pump to adjust the actual output pressure for the pump towards a target output pressure based at least in part on the correlation between the prediction error and the input pump parameter. Specifically, as indicated above, the computing system 400 (e.g., via the controller 120) may be configured to control the operation of the pump 102 to “step up” or “step down” the pump's output pressure based on an analysis of the correlation between the prediction error and pump fractional displacement. For example, as described above with reference to FIG. 7, the computing system 400 may be configured to compare a SMA cross-correlation value to a LMA cross-correlation value to determine whether an increase or decrease if the pump output pressure should be made. The computing system 400 may then control the operation of the pump 102 based on the determined pressure adjustment (e.g., by transmitting an appropriate control command to the pump 102).

It is to be understood that the steps of the method 500 are performed by the computing system 400 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 400 described herein, such as the control logic 200, 300 and/or method 500, is implemented in software code or instructions which are tangibly stored on a tangible computer readable medium. The computing system 400 loads the software code or instructions via a direct interface with the computer readable medium or via a wired and/or wireless network. Upon loading and executing such software code or instructions by the computing system 400, the computing system 400 may perform any of the functionality of the computing system 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A method for controlling an operation of a pump of a work vehicle when supplying pressurized fluid to an implement coupled to the work vehicle, the method comprising:
receiving, with a computing system, data indicative of an actual output pressure for the pump and an input pump parameter associated with the pump;
determining, with the computing system, a predicted output pressure for the pump based at least in part on the input pump parameter;
determining, with the computing system, a prediction error based at least in part on the actual and predicted output pressures for the pump;
determining, with the computing system, a correlation between the prediction error and the input pump parameter;
controlling, with the computing system, the operation of the pump to adjust the actual output pressure for the pump towards a target output pressure based at least in part on the correlation between the prediction error and the input pump parameter.

2. The method of claim 1, wherein determining the predicted output pressure comprises:
determining, with the computing system, an estimated output flow rate for the pump based at least in part on the input pump parameter;
determining, with the computing system, the predicted output pressure based at least in part on the estimated output flow rate and an estimated input flow rate supplied to the implement.

3. The method of claim 2, wherein the prediction error incorporates a system error deriving at least in part from the estimated input flow rate supplied to the implement such that the correlation between the prediction error and the input pump parameter is lower when the actual output pressure for the pump is greater than the target output pressure and higher when the actual output pressure is lower than the target output pressure.

4. The method of claim 1, wherein the prediction error incorporates a system error deriving at least in part from an estimated input flow rate supplied to the implement such that the correlation between the prediction error and the input pump parameter is lower when the actual output pressure for the pump is greater than the target output pressure and higher when the actual output pressure is lower than the target output pressure.

5. The method of claim 1, further comprising determining a moving average for the correlation between the prediction error and the input pump parameter.

6. The method of claim 5, wherein controlling the operation of the pump comprises controlling the operation of the pump to adjust the actual output pressure for the pump towards the target output pressure based at least in part on the moving average for the correlation.

7. The method of claim 6, wherein the moving average comprises a first moving average for the correlation determined across a time period and further comprising determining a second moving average for the correlation across two or more of the time periods.

8. The method of claim 7, further comprising comparing the first moving average for the correlation to the second moving average for the correlation; and
wherein controlling the operation of the pump comprises decreasing the actual output pressure for the pump towards the target output pressure when the first moving average for the correlation is within a threshold amount of the second moving average and increasing the actual output pressure for the pump towards the target output pressure when the first moving average is not within the threshold amount of the second moving average.

9. The method of claim 8, wherein the first moving average for the correlation is incorporated into the second moving average for the correlation when the operation of the pump is controlled to decrease the actual output pressure and excluded from the second moving average for the correlation when the operation of the pump is controlled to increase the actual output pressure.

10. The method of claim 1, wherein controlling the operation of the pump comprises:
determining a nominal pressure setpoint for the pump based at least in part on the correlation between the prediction error and the input pump parameter;
applying a perturbation signal to the nominal pressure setpoint to generate a final output pressure command for the pump; and
controlling the operation of the pump using the final output pressure command.

11. The method of claim 1, wherein the input pump parameter comprises a fractional pump displacement of the pump.

12. A system for supplying pressurized fluid from work vehicles to external implements, the system comprising:
a work vehicle coupled to an implement, the work vehicle including a pump configured to supply pressurized hydraulic fluid to a hydraulic component of the implement;
a computing system communicatively coupled to the pump, the computing system being configured to:
receive data indicative of an actual output pressure for the pump and an input pump parameter associated with the pump;
determine a predicted output pressure for the pump based at least in part on the input pump parameter;
determine a prediction error based at least in part on the actual and predicted output pressures for the pump;
determine a correlation between the prediction error and the input pump parameter;
control the operation of the pump to adjust the actual output pressure for the pump towards a target output pressure based at least in part on the correlation between the prediction error and the input pump parameter.

13. The system of claim 12, wherein the computing system is further configured to determine an estimated output flow rate for the pump based at least in part on the input pump parameter, wherein the predicted output pressure is determined based at least in part on the estimated output flow rate and an estimated input flow rate supplied to the implement.

14. The system of claim 13, wherein the prediction error incorporates a system error deriving at least in part from the estimated input flow rate supplied to the implement such that the correlation between the prediction error and the input pump parameter is lower when the actual output pressure for the pump is greater than the target output pressure and higher when the actual output pressure is lower than the target output pressure.

15. The system of claim 12, wherein the prediction error incorporates a system error deriving at least in part from an estimated input flow rate supplied to the implement such that the correlation between the prediction error and the input pump parameter is lower when the actual output pressure for the pump is greater than the target output pressure and higher when the actual output pressure is lower than the target output pressure.

16. The system of claim 12, wherein the computing system is further configured to determine a moving average for the correlation between the prediction error and the input pump parameter, the computing system being configured to control the operation of the pump to adjust the actual output pressure for the pump towards the target output pressure based at least in part on the moving average for the correlation.

17. The system of claim 16, wherein the moving average comprises a first moving average for the correlation determined across a time period and wherein the computing system is further configured to determine a second moving average for the correlation across two or more of the time periods,
wherein the computing system is configured to:
compare the first moving average for the correlation to the second moving average for the correlation; and
control the operation of the pump by decreasing the actual output pressure for the pump towards the target output pressure when the first moving average for the correlation is within a threshold amount of the second moving average and by increasing the actual output pressure for the pump towards the target output pressure when the first moving average is not within the threshold amount of the second moving average.

18. The system of claim 17, wherein the computing system is configured to incorporate the first moving average for the correlation into the second moving average for the correlation when the operation of the pump is controlled to decrease the actual output pressure and exclude first moving average for the correlation from the second moving average for the correlation when the operation of the pump is controlled to increase the actual output pressure.

19. The system of claim 12, wherein the computing system is further configured to determine a nominal pressure setpoint for the pump based at least in part on the correlation between the prediction error and the input pump parameter and apply a perturbation signal to the nominal pressure setpoint to generate a final output pressure command for the pump, the computing system controlling the operation of the pump using the final output pressure command.

20. The system of claim 12, wherein the input pump parameter comprises a fractional pump displacement of the pump.
